(19) United States
(12) Patent Application Publication
(10) Pub. No.: US 2007/0262158 A1
(43) Pub. Date: Nov. 15, 2007

(54) Card multimedia method and system

(76) Inventor: Kurtis J. Ritchey, Leavenworth, KS (US)

Correspondence Address: CARDINAL LAW GROUP, Suite 2000, 1603 Orrington Avenue, Evanston, IL, 60201, US

(21) Appl. No.: 11/432,647

(22) Filed: May 11, 2006

(51) Int. Cl. G06K 19/06

(52) U.S. Cl. 235/492

(57) ABSTRACT

A card display comprising a memory storage unit, an electronic paper operable to receive imagery from the memory storage unit, and a battery providing electrical power to the electronic paper and the memory unit.

### RELATED APPLICATIONS

This is a Continuation-in-part to Provisional Applications entitled Wireless Panoramic Image Based Virtual Reality/Telepresence Personal Communication System and Method by Kurtis J. Ritchey, and Panoramic Volumetric Panoramic Senor System and Method by Kurtis J. Ritchey.

### BACKGROUND OF THE INVENTION

Traditionally, people have carried photographs and printed material of subjects with them printed on paper. It was convenient because paper was thin and various information could be easily printed onto the paper. While this prior art served its purpose, it was limited in that printed material was typically not changeable and was limited to a single image on the paper. And because of this a whole stack of photographs or cards were required to be carried in their billfold or purse in order for a carrier to have all the information they needed to have with them. Recent electronics lend themselves to solving some of these limitations. For instance, electronic paper is very thin and the images can be changeable. Prior art electronic paper, control unit, memory, and a power system of a type that enables and is integrated into the present invention includes U.S. Provisional Patent Application Publication 2002/0030638 by Weiner in 14 Mar. 2002. Memory may be Random Access Memory or Read Only Memory (EPROM). Memory may be removable and or permanent in the videocard or multimedia card. The battery provides electrical power to the electronic paper, memory unit, control unit, and other components of the videocard. Conventional small camera batteries used in a camera or watch may be used. Alternatively, the battery may be replaced or recharged by solar cells that are mounted opposite the viewing side of the videocard. Solar cells of type that enables and is integrated into the present invention includes the flexible MIT battery, laminated to the back of a flexible solar cell. Optionally, the videocard may include an optical lens screen that enables autostereoscopic viewing, and include storage of an image or video in an interlaced manner to that works with the optical lens screen to enable autostereoscopic viewing. Autostereoscopic arrangements of a type that enables and is integrated into the present invention includes those mentioned by Ritchey in related disclosures. Optionally, also, the videocard includes encryption and security features built in. Optionally the videocard has an infrared sensor built in that initiates and turns off the active display. The card may include an audio capability, to include a speaker. The card may have wireless communication components like a Bluetooth, IEEE 802.11b, other WIFI wireless standards and cellular phone components built into the cards circuitry. And the card may have a camera built into the circuitry. The camera system may be built stowed manner for easy carrying and then rotated in a manner for spherical optical coverage. Additionally, the wireless communication card may be mad to fold up for easy carrying and unfold to stand on its own for improved or optimal display and image capture by the user. The video card may also come apart to provide a handheld device that is in communicating relationship with display glasses worn by the user/viewer. The electronic paper glasses may or may not be see-thru depending on the application. Eyeglasses with a transmission system that is of a type that is integrated into the substrata of the device of the present invention is found in U.S. Pat. No. 6,816,132 by Tanijiri et al. dated 9 Nov. 2004. The glasses may or may not include a camera system built in. The IR or motion sensor may be active (battery powered) or passive (not battery powered). Shape sensor of a type that may be integrated into the present invention included that shown in U.S. Pat. Mentioned by Ritchey in related patent disclosures. And, finally, the card may be worn on the users clothing or as a bracelet, for instance on his or her wrist. In operation, the user pushes a play button on the videocard which activates the memory section of the card to transmit photos and/or a short video to the electronic display of the videocard. The user then observes the video played on the videocard and reacts or interacts.

### SUMMARY OF THE INVENTION

An improved substitute for a photograph carried in a person's billfold in the form of a thin “VideoCard” TM is provided. The videocard comprises thin electronic paper which receives imagery from a memory storage unit, a play button, and a battery. The battery provides electrical power to the electronic paper, memory unit, control unit, and other components of the videocard. Alternatively, the battery may be replaced or recharged by solar cells that are mounted opposite the viewing side of the videocard. Optionally, the videocard may include an optical lens screen that enables autostereoscopic viewing, and include storage of an image or video in an interlaced manner to that works with the optical lens screen to enable autostereoscopic viewing. Optionally also, the videocard includes encryption and security features built in. Optionally, the videocard has an infrared sensor built in that initiates and turns off the active display. And the card may include an audio capability, to include a speaker. The card may have wireless communication components like a Bluetooth, IEEE, and cellular phone components built into the cards circuitry. The card may have a camera built into the circuitry. And, finally, the card may be worn by the user, for example, on his or her wrist. In operation, the user pushes a play button on the videocard which activates the memory section of the card to transmit photos and/or a short video to the electronic display of the videocard. The user then observes the video played on the videocard.

### OBJECT OF THE INVENTION

To provide an improved device on which imagery may be viewed; such that the device provides a substitute for a photograph, thus facilitating easy portability; such that a number of pre-recorded photographs may be stored in the memory of the device, thus alleviating the need to carry video diskettes and cassettes; and allowing cost effective use of the videocard because it can be reloaded with different pictures or other information; and, optionally, a method and device design to facilitate autostereoscopic viewing that provides the illusion of three dimensional depth while viewing the photograph or video on the electronic paper display of the videocard. Some other applications for VideoCard TM include sports and movie trading cards, identification cards, business and credit cards, and family photos. Still other even more advanced applications that are built into the card include camera, audio, personal assistant, and cellular capabilities.

### BRIEF DESCRIPTION OF THE DRAWINGS

FIG. 1 shows a perspective drawing of the front side of a first embodiment of the Card Display system according to the present invention.

FIG. 2 shows a block diagram of the components of the Card Display system according to the first embodiment of the present invention.

FIG. 3 shows a perspective drawing of the front side of a second embodiment of the Card Display system according to the present invention.

FIG. 4 shows a block diagram of the components of the Card Display system according to the second embodiment of the present invention.

FIGS. 5 and 6 show a drawing of a personal communication device card system in accordance with the present invention.

FIG. 7 shows a pocket carrier/control unit in accordance with the present invention.

### DETAILED DESCRIPTION OF THE INVENTION

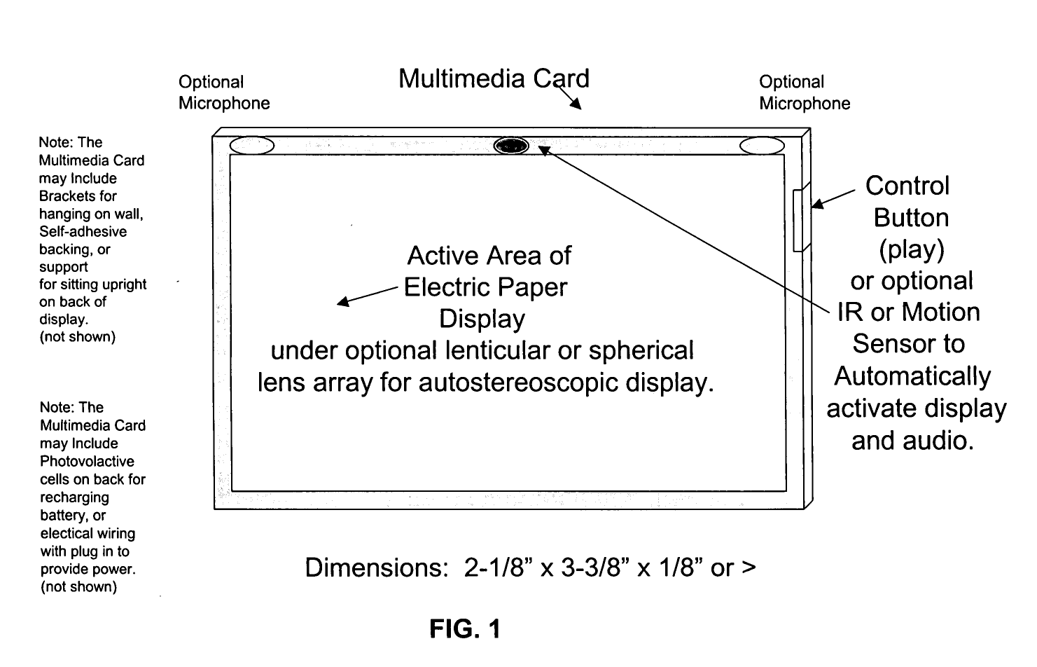

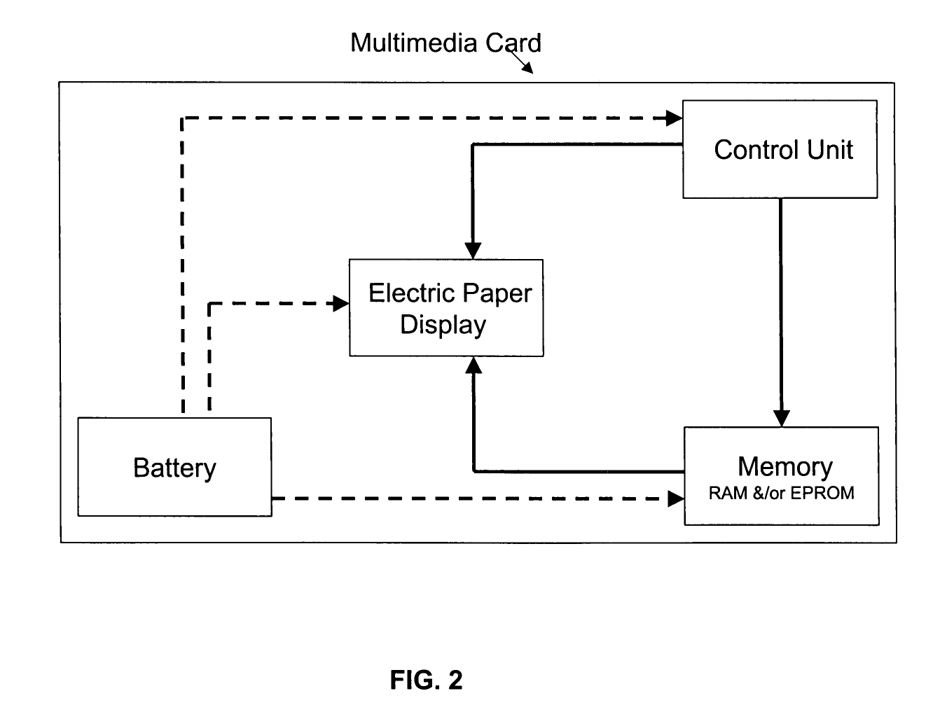

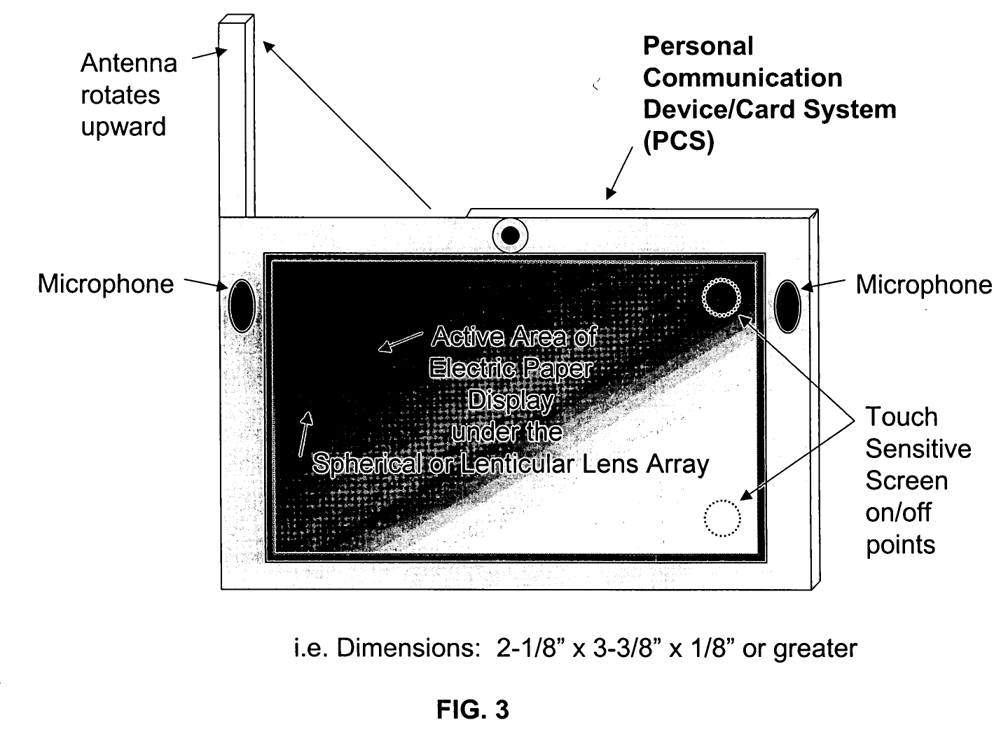

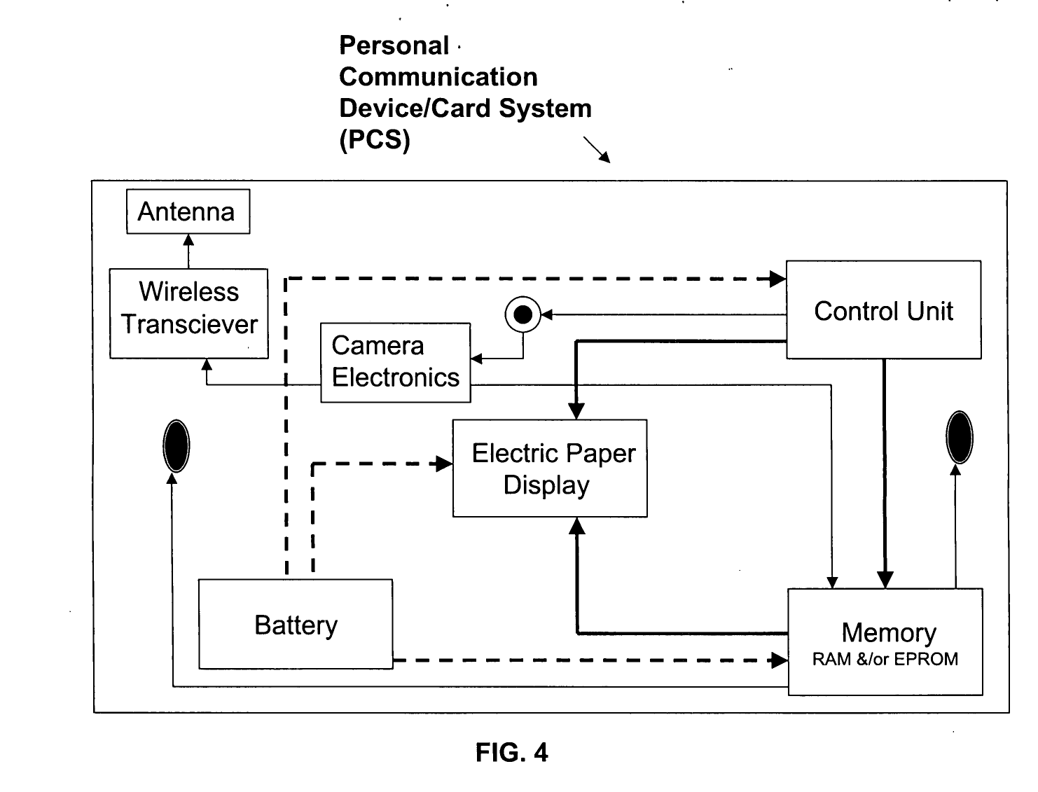

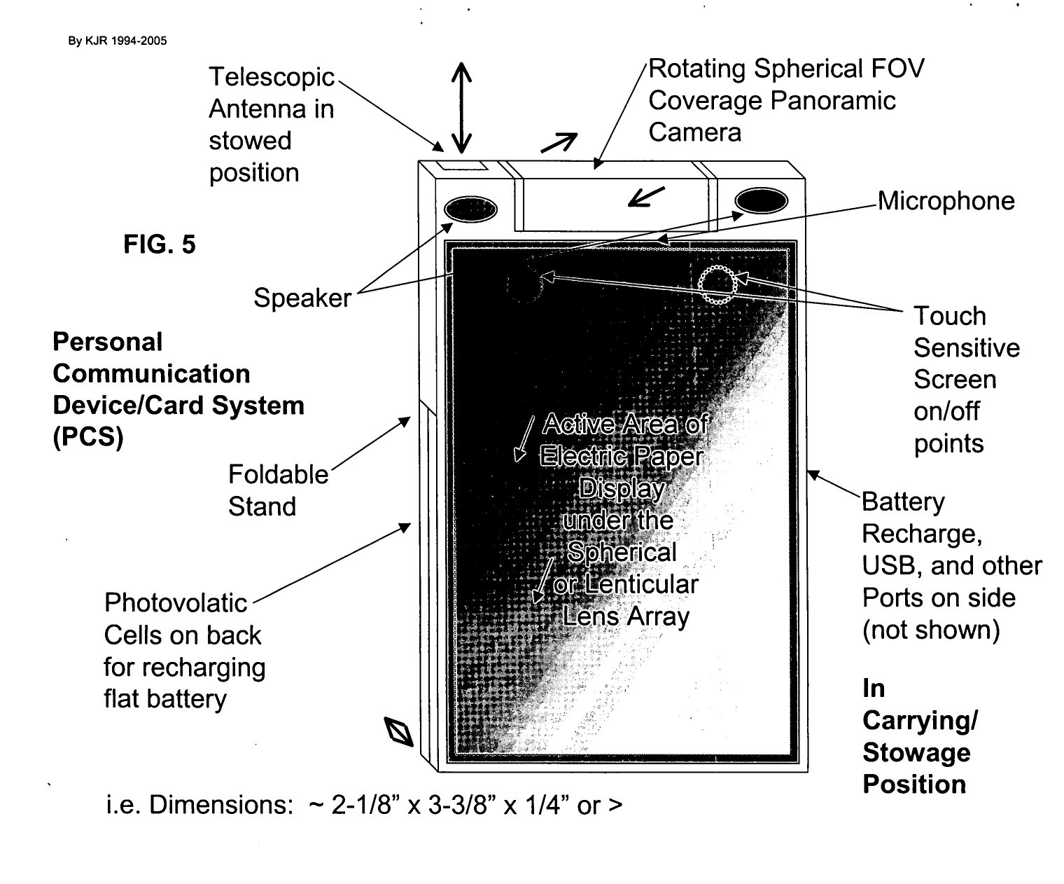

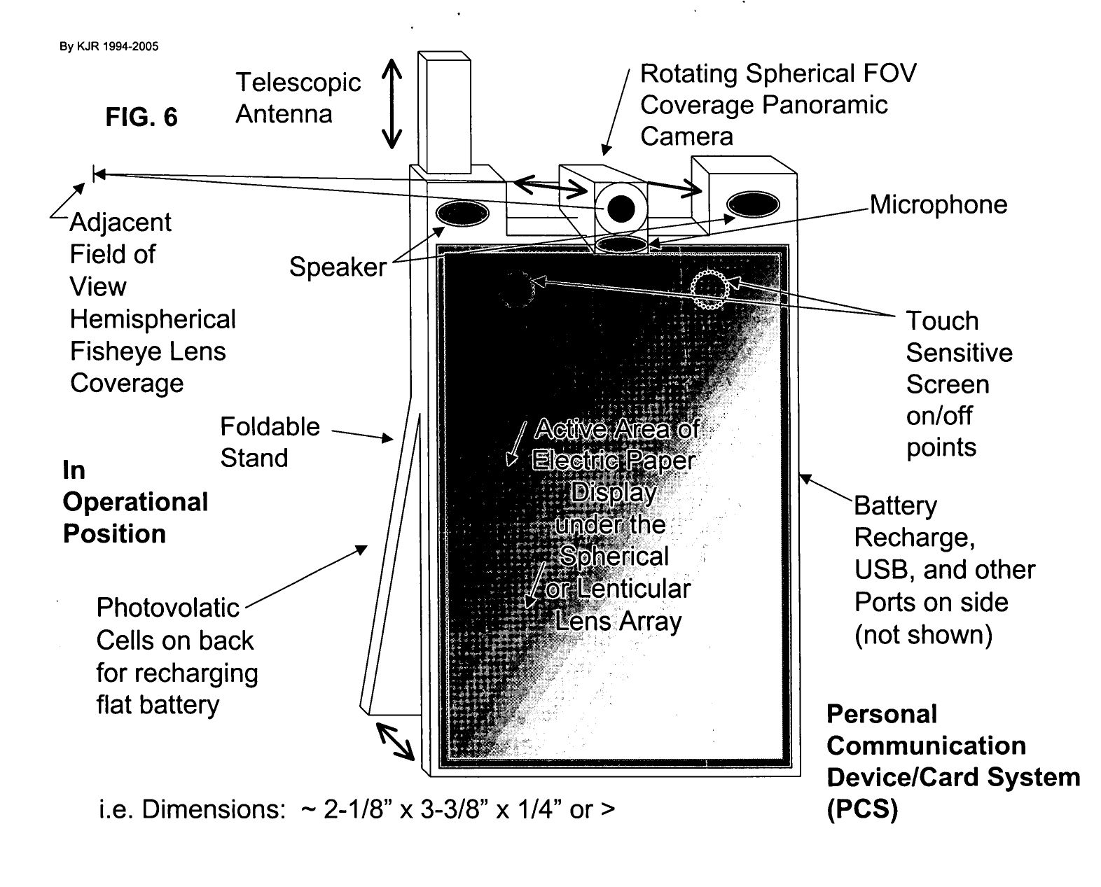

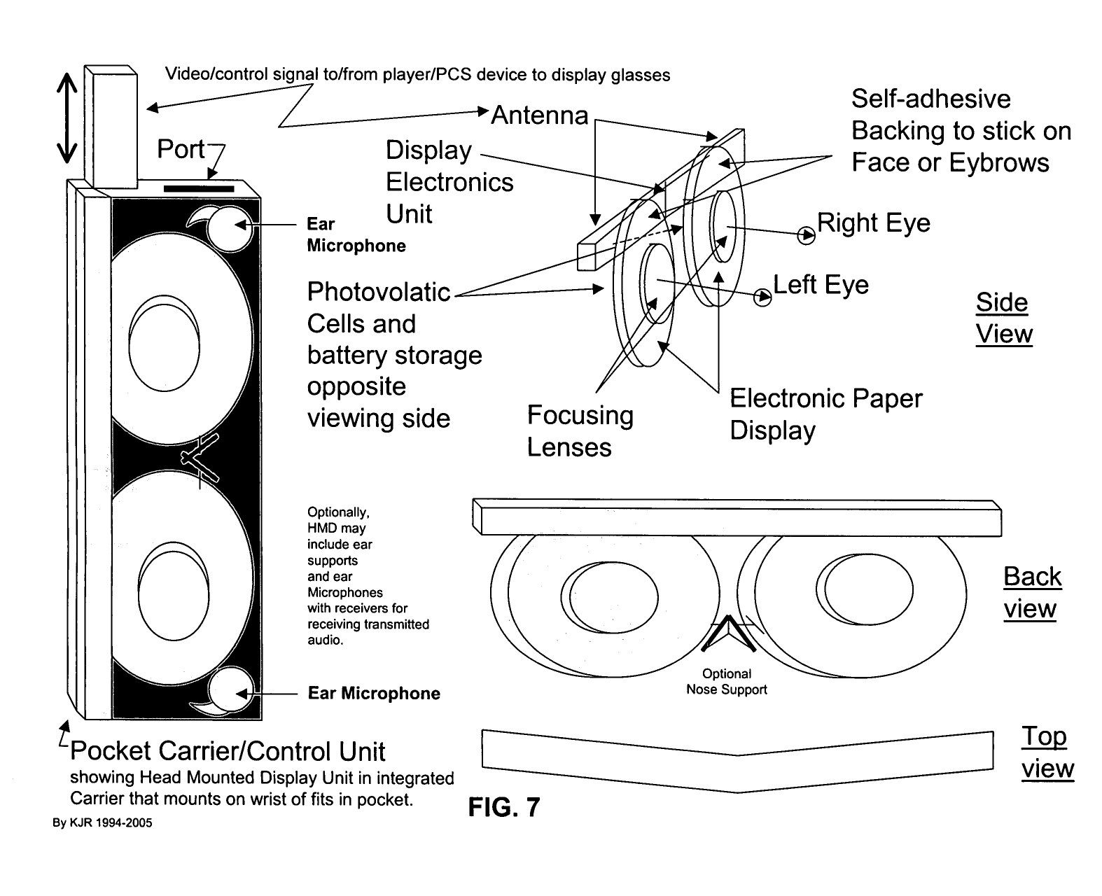

Referring to the drawings, FIG. 1 shows a perspective drawing of a simple Card Display system for use in applications like sports trading cards, identification cards, or to display family photos. The videocard comprises thin electronic paper which receives imagery from a memory storage unit, a play button, and a battery. The battery provides electrical power to the electronic paper, memory unit, control unit, and other components of the videocard.

1. A card display, comprising:
a memory storage unit;
electronic paper operable to receive imagery from the memory storage unit; and
a battery providing electrical power to the electronic paper and the memory unit.
